(19) United States
(12) Patent Application Publication
(10) Pub. No.: US 2011/0126915 A1
(43) Pub. Date: Jun. 2, 2011

(54) FLUID RECOVERY DEVICE AND RECOVERY METHOD USING THE SAME

(75) Inventors: HSIEN-TSUNG LI, Tu-Cheng (TW); HUI-JU LIN, Tu-Cheng (TW)

(73) Assignee: HON HAI PRECISION INDUSTRY CO., LTD., Tu-Cheng (TW)

(21) Appl. No.: 12/844,973

(22) Filed: Jul. 28, 2010

(30) Foreign Application Priority Data
Nov. 27, 2009 (TW) 98140473

(51) Int. Cl. F15D 1/00

(52) U.S. Cl. 137/14; 137/565.01

(57) ABSTRACT

A fluid recovery device includes a receiving vessel for receiving a recovered fluid, a pump, a fluid container, and a conduit communicating the receiving vessel, the pump, and the fluid container successively, and the pump is turned on or off at a predetermined time interval. A method for recovering fluid uses the fluid recovery device.

### BACKGROUND

1. Technical Field

The present disclosure relates to a fluid recovery device and a recovery method using the same.

2. Description of Related Art

When a fluid ejection apparatus ejects fluid onto a target, such as an inkjet printer ejecting ink onto a recording medium, only a portion of the fluid is retained on the target, while other droplets are recycled to reduce the cost.

When the fluid is ejected from a fluid ejection apparatus, volatile components evaporate, thereby increasing viscosity of the recovered fluid, that is, increased ink dye concentration is resulted. Commonly usedly, in an inkjet printer, the viscosity of the recovered fluid should be in a range from a viscosity of an original fluid sprayed from the inkjet printer to 8.5 Centipoises (CP), in other words, the viscosity of the recovered fluid should be limited.

Referring to FIG. 3, a conventional fluid recovery device 10 includes a funnel 11 and a receiving vessel 12 positioned therebelow. In use, an original fluid 13 is sprayed from a fluid ejection device 14, with a portion thereof sprayed over a workpiece 15, and the excess fluid is received in the funnel 11, flows into the receiving vessel 12, and is collected as a recovered fluid 16. Viscosities of the original fluid 13 and the recovered fluid 16 in the receiving vessel 12 are shown in the Table 1.

TABLE 1
Viscosities of the original fluid and the recovered fluid

| | Viscosity of the | Viscosity of the |
|---|---|---|
| Date | original fluid (CP) | recovered fluid (CP) |
| 2009 Jul. 28, | 4.14 | 7.65 |
| 2009 Jul. 29, | 4.34 | 8.10 |
| 2009 Jul. 29, | 4.34 | 7.80 |

According to the test data shown in Table 1, the viscosity of the recovered fluid 16 is less than 8.5 CP, which allows for reuse. The original fluid 13 received by the funnel 11 is flowed into the receiving vessel 12 directly, such that only the fluid at a surface layer contacts the air, and thus fewer volatile components are evaporated therefrom, allowing the viscosity of the recovered fluid 16 to remain within the acceptable range from the viscosity of the original fluid 13 to 8.5 CP. Gravitational force draws the original fluid 13 into the receiving vessel 12. Since, however, one end of the funnel 11 is a narrow tube received in the receiving vessel 12 to limit entry of air, the flow rate of the original fluid 13 in the funnel 11 is relatively low, and the conventional fluid recovery device 10 has lower recovery efficiency.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of one embodiment of a fluid recovery device.

FIG. 2 is a flow chart of one embodiment of a recovery method.

FIG. 3 is a schematic view of a commonly-used conventional fluid recovery device.

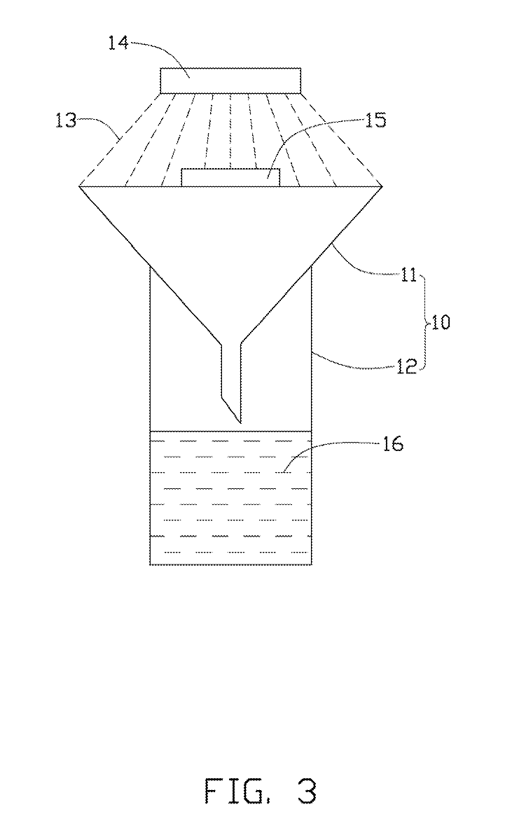

### DETAILED DESCRIPTION

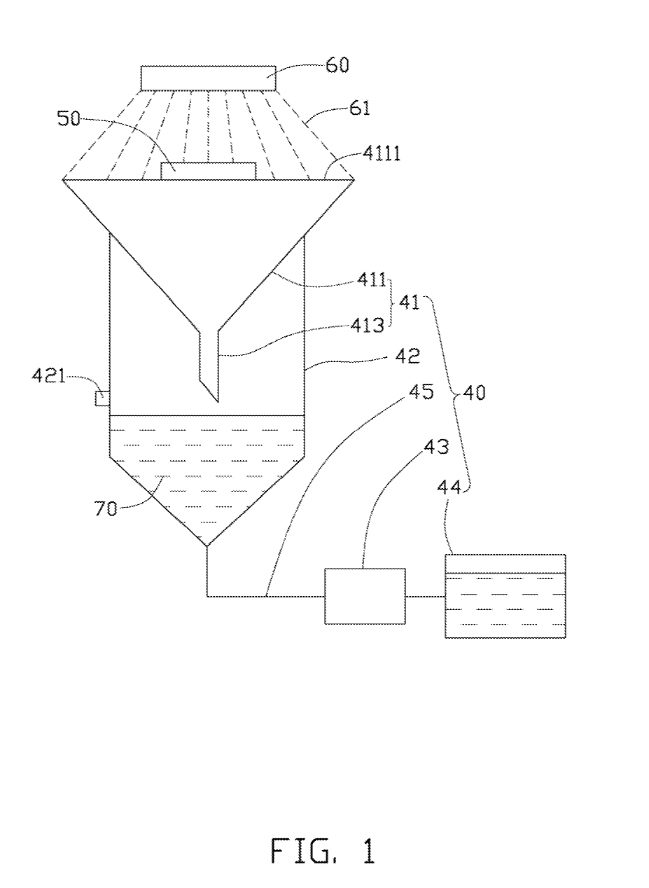

The disclosed fluid recovery device may be used in cleaning or inkjet printing. Referring to FIG. 1, a fluid recovery device 40 includes a funnel 41, a receiving vessel 42, a pump 43, a fluid container 44, and a conduit 45. The conduit 45 communicates the receiving vessel 42, the pump 43, and the fluid container 44 successively. In the illustrated embodiment, the fluid recovery device 40 is used in an inkjet printing process. A workpiece 50 is positioned adjacent to the funnel 41, and an inkjet printing device 60 is positioned above the workpiece 50. The inkjet printing device 60 is configured to spray a set amount of ink 61 over the workpiece 50.

The funnel 41 includes a receiving portion 411 and a guide portion 413 formed at an end of the receiving portion 411. The receiving portion 411 is a substantially hollow cone and the guide portion 413 extends from a smaller end of the receiving portion 411. The receiving portion 411 defines an opening 4111 in an end away from the guide portion 413. The workpiece 50 is positioned adjacent to the opening 4111. The guide portion 413 is a tube and communicates with the receiving portion 411. An end of the guide portion 413 away from the receiving portion 411 is received in the receiving vessel 42. The workpiece 50 may be positioned adjacent to the opening 4111 of the funnel 41 by a conveyor belt (not shown).

The receiving vessel 42 is configured to collect the ink 61 flowing from the funnel 41, which is then collected as a recovered fluid 70. To monitor fluid level of the recovered fluid 70 in the receiving vessel 42, the receiving vessel 42 is equipped with a fluid level monitoring device 421. In the illustrated embodiment, the conduit 45 is fixed to a lower end of the receiving vessel 42 and communicates with the receiving vessel 42, such that the recovered fluid 70 in the receiving vessel 42 can be impelled by the pump 43 completely.

The pump 43 is positioned between the receiving vessel 42 and the fluid container 44. When the pump 43 is turned off, the fluid container 44 is substantially isolated from the fluid recovery device or system, maintaining lower pressure or a vacuum therein. The fluid container 44 may further include a cover (not shown) to block light, thus minimizing evaporation of the solvent from the recovered fluid 70. In the illustrated embodiment, the fluid recovery device 40 includes a covering cloth (not shown) covering the fluid container 44, although other material can be used.

If the fluid recovery device 40 remains idle for an extended period of time, components thereof may experience drying, which can increase the viscosity of the recovered fluid 70. It is thus necessary to spray the ink 61 to flush the fluid recovery device 40 using the original fluid 13 and remove the recovered fluid 70 before the inkjet printing device 60 then sprays the ink 61 over the workpiece 50.

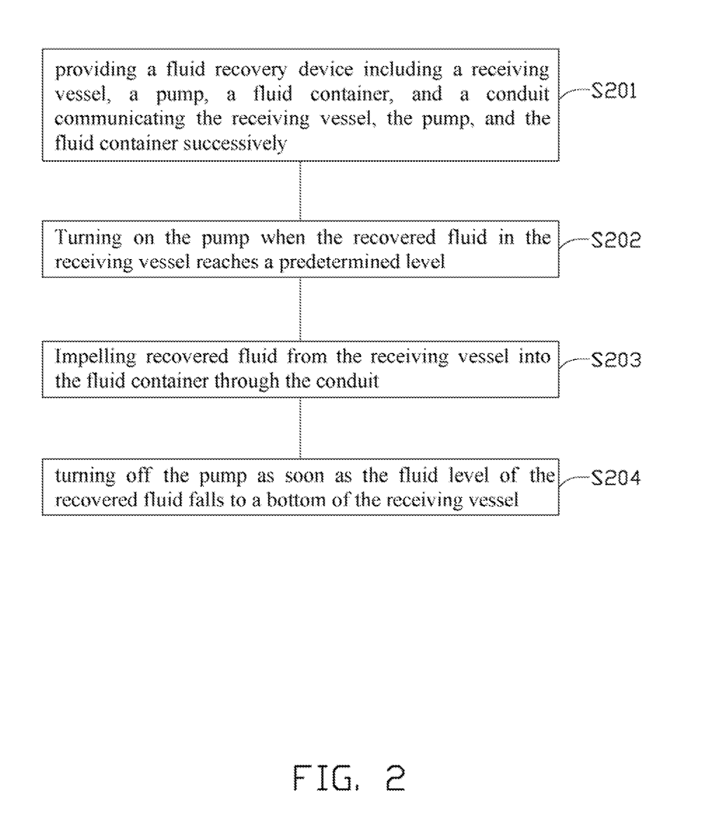

Referring to FIG. 2, When the inkjet printing device 60 sprays the ink 61 over the workpiece 50, a recovery method using the fluid recovery device 40 is executed, as follows.

In step S201, providing a fluid recovery device 100 including a receiving vessel 42, a pump 43, a fluid container 44, and a conduit 45 communicating the receiving vessel 42, the pump 43, and the fluid container 45 successively. The ink 61 received by the receiving portion 411 of the funnel 41 flows into the receiving vessel 42 through the guide portion 413, and the fluid collected in the receiving portion 411 is named the recovered fluid 70.

In step S202, the pump 43 is turned on when the recovered fluid 70 in the receiving vessel 42 reaches a predetermined level.

In step S203, the recovered fluid 70 collected in the receiving vessel 42 is impelled by the pump 43 into the fluid container 44.

In step S204, the pump 43 is turned off as soon as the fluid level of the recovered fluid 70 falls to the bottom of the receiving vessel 42. The fluid level monitoring device 421 monitors the level of the recovered fluid 70 in the receiving vessel 42, and the pump 43 is turned off as soon as the fluid level of the recovered fluid 70 falls to an end of the conduit 45 adjacent to the receiving vessel 42. In other words, the fluid level of the recovered fluid 70 falls to the bottom of the receiving vessel 42.

If it is necessary to further recover the recovered fluid 70 in the receiving vessel 42, the steps S202-S204 may be repeated, otherwise the fluid recovery is completed.

In the illustrated embodiment, the pump 43 is turned on if the fluid level of the recovered fluid 70 in the receiving vessel 42 rises to a height of 7.5 mm relative to the bottom of the receiving vessel 42, and the pump 43 is turned on or off at predetermined time intervals of 45 seconds.

During the recovery of the ink 61, the viscosity of the recovered fluid 70 in the fluid container 44 is measured periodically. In the illustrated embodiment, the viscosity of the recovered fluid 70 is measured at regular time intervals of 80 minutes. The viscosities of the ink 61 and the recovered fluid 70 in the fluid container 44 are shown in Table 2.

TABLE 2
Viscosities of the ink and the recovered fluid

| | Viscosity of the | Viscosity of the | Viscosity of the |
|---|---|---|---|
| Date | ink (CP) | recovered fluid (CP) | recovered fluid (CP) |
| 2009 Jul. 30, | 4.34 | 8.10 | 7.80 |

According to the test data shown in Table 2, the viscosity of the recovered fluid 70 is measured twice, and each viscosity measurement is less than 8.5 CP, thus the recovered fluid 70 can be reused.

The recovered fluid 70 in the receiving vessel 42 is pumped into the fluid container 44 every 45 seconds, and the fluid container 44 is a container under vaccum, such that the time duration of the recovered fluid 70 exposed to the air is very short, and thus less solvent is evaporated. Moreover, the pump 43 is turned off before all of the recovered fluid 70 in the receiving vessel 42 and the conduit 45 is pumped into the fluid container 44, thus avoiding entry of air into the recovery system. Overall exposure to air is thereby decreased, and the viscosity of the recovered fluid 70 is thus controlled.

The recovery method is capable of more efficient fluid recovery, thereby ensuring improved quality or consistency of the recovered fluid 70.

The fluid level monitoring device 421 may be omitted, wherein the fluid level of the recovered fluid 70 in the receiving vessel 42 can be manually monitored.

When the recovered fluid 70 is pumped from the receiving vessel 42 into the fluid container 44, the pump 43 is turned off as soon as the fluid level of the recovered fluid 70 falls to the bottom of the receiving vessel 42, or the pump 43 is turned off no matter how little amount of the recovered fluid 70 is in the receiving vessel 42 so as to prevent air from entering the fluid container 44.

The funnel 41 may be omitted, whereby the receiving vessel 42 defines a larger opening adjacent to where the workpiece 50 is positioned, such that excess amount of the ink 61 sprayed over the workpiece 50 is retrieved in the receiving vessel 42.

The fluid recovery device 40 may further include a regulating device (not shown) communicating with the fluid container 44, for regulating the viscosity of the recovered fluid 70 in the fluid container 44 and feeding the recovered fluid 70 back to the inkjet printing device 60.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A fluid recovery device, comprising:
a receiving vessel for receiving fluid;
a pump;
a fluid container; and
a conduit communicating the receiving vessel, the pump, and the fluid container successively, wherein the pump is turned on or off at a predetermined time interval.

2. The fluid recovery device of claim 1, wherein the fluid container includes a cover.

3. The fluid recovery device of claim 1, further comprising a cover covering the fluid container to block light.

4. The fluid recovery device of claim 1, wherein the interior of the fluid container under vacuum.

5. The fluid recovery device of claim 1, further comprising a funnel for transferring the fluid into the receiving vessel.

6. The fluid recovery device of claim 5, wherein the funnel comprises a receiving portion and a guide portion extending from an end of the receiving portion, and the receiving portion is received in the receiving vessel.

7. The fluid recovery device of claim 1, further comprising a fluid level monitoring device positioned on the receiving vessel for monitoring the fluid level of the recovered fluid in the receiving vessel.

8. A recovery method, comprising:
(a) providing a fluid recovery device comprising a receiving vessel, a pump, a fluid container, and a conduit communicating the receiving vessel, the pump, and the fluid container successively;
(b) turning on the pump as soon as the fluid level of a recovered fluid in the receiving portion reaches a predetermined level;
(c) pumping the recovered fluid from the receiving vessel into the fluid container through the conduit;
(d) turning off the pump as soon as the fluid level of the recovered fluid falls to a bottom of the receiving vessel; and
repeating the steps (b) through (d) if additional recovery of the recovered fluid is required.

9. The recovery method of claim 8, wherein the interior of the fluid container is under vacuum before the recovered fluid is pumped thereinto.

10. The recovery method of claim 8, wherein the pump is turned on if the fluid level of the recovered fluid in the receiving vessel rises to a height of 7.5 mm relative to a bottom of the receiving vessel.

11. The recovery method of claim 8, wherein the pump is turned on or off at a predetermined time interval.

12. The recovery method of claim 8, wherein the pump is turned on or off at time intervals of 45 seconds.

13. The recovery method of claim 8, further comprising, before recovery, flushing the receiving vessel and the pump with an original fluid, and removing the recovered fluid.

14. The recovery method of claim 8, wherein the fluid recovery device further comprises a fluid level monitoring device to monitor the fluid level in the receiving vessel.

15. A recovery method, comprising:
providing a fluid recovery device comprising a receiving vessel, a pump, a fluid container, and a conduit communicating the receiving vessel, the pump, and the fluid container successively;
(a) turning the pump on or off at a predetermined time interval;
(b) turning on the pump as soon as a recovered fluid in the receiving portion reaches a predetermined level;
(c) pumping the recovered fluid from the receiving vessel into the fluid container through the conduit;
(d) turning off the pump before the fluid level of the recovered fluid falls to a bottom of the receiving vessel; and
repeating the steps (a) through (d) if additional recovery of the recovered fluid is required, otherwise ending the recovery.
